(19) United States
(12) Patent Application Publication
(10) Pub. No.: US 2026/0046590 A1
(43) Pub. Date: Feb. 12, 2026

(54) LATENCY-BASED ROBOT DRIVING MAP GENERATION APPARATUS AND METHOD

(71) Applicants: Hyundai Motor Company, Seoul (KR); KIA CORPORATION, Seoul (KR); SUNGSHIN WOMEN’S UNIVERSITY R&DB FOUNDATION, Seoul (KR)

(72) Inventors: Jongmin Kim, Hwaseong-si (KR); Seong Wook Hwang, Seoul (KR); Jeong Min Oh, Seoul (KR); Hyo Jin Song, Incheon (KR); Yujin Song, Dongducheon-si (KR); Namgyo Kim, Chuncheon-si (KR); Joon Young Kim, Seoul (KR); Sihyeon Park, Chungju-si (KR)

(73) Assignees: HYUNDAI MOTOR COMPANY, Seoul (KR); KIA CORPORATION, Seoul (KR); SUNGSHIN WOMEN’S UNIVERSITY R&DB FOUNDATION, Seoul (KR)

(21) Appl. No.: 18/981,044

(22) Filed: Dec. 13, 2024

(30) Foreign Application Priority Data
Aug. 6, 2024 (KR) 10-2024-0104443

(51) Int. Cl. H04W 4/024; G05D 1/656; G05D 105/80; H04W 64/00

(52) U.S. Cl. CPC H04W 4/024; G05D 1/656; H04W 64/003; G05D 2105/87

(57) ABSTRACT

A latency-based robot driving map generation apparatus includes a network map generator configured to divide a space into grids and measure network latency for each grid to generate a network map with assigned latency levels. The apparatus further includes a success rate calculator configured to calculate success rates by repeated driving operations on paths within grids assigned specific latency levels in the network map. Additionally, a driving path determiner determines a driving path on the network map based on the assigned latency levels and the calculated success rates.

### CROSS-REFERENCE TO RELATED APPLICATION

This application claims priority to and the benefit of Korean Patent Application No. 10-2024-0104443 filed in the Korean Intellectual Property Office on Aug. 6, 2024, the entire contents of which are incorporated herein by reference.

### BACKGROUND OF THE INVENTION

### (a) Field of the Invention

The present disclosure relates to a latency-based robot driving map generation apparatus and method, and particularly, to a latency-based robot driving map generation apparatus and method that generate a driving map of a mobile robot by reflecting a network situation.

### (b) Description of the Related Art

Currently, when creating a map for a robot to drive autonomously, elements that affect robot driving, such as obstacles, glass walls, and spaces with a lot of reflective materials in a robot driving space, are scanned. Accordingly, when it is determined that stable driving is impossible, a robot driving prohibition is set on the map to secure driving stability.

Network-related issues that could affect robot driving and service operations are typically identified during field tests after configuring a service scenario.

In wireless networks, latency may occur depending on various external factors, such as the number of users connected to the network, weather, and modem/router status, and such latency may cause problems in the robot driving and service.

### SUMMARY OF THE INVENTION

The present disclosure aims to provide a latency-based robot driving map generation apparatus and method that additionally manage network status variables and service success rate indicators for an existing map so that robot driving and service are not performed in an area where latency is always high, and sets path priorities based on success rate data in an area where the latency occurs intermittently.

The present disclosure aims to provide a latency-based robot driving map generation apparatus and method that make a space into grids, measures network latency for each grid, generates a network map to which levels are assigned, calculates a success rate according to statistical figures through path repetition, updates the network map based on the success rate, and determines a driving path selection priority according to the latency level and success rate.

According to an exemplary embodiment, a latency-based robot driving map generation apparatus may include: a network map generator that divides a space into grids and measures network latency for each grid to generate a network map with assigned latency levels; a success rate calculator that calculates success rates by repeatedly driving on a path within a grid assigned a specific latency level; and a driving path determiner that selects driving paths on the network map based on latency levels and success rates.

The network map generator may determine the latency level as a first level when the network latency is equal to or greater than a first criterion, a second level when the network latency is less than the first criterion and equal to or greater than a second criterion, and a third level when the network latency is less than the second criterion and equal to or greater than a third criterion, and the first to third criteria may vary based on a service operation status of a driving robot.

The driving path determiner may exclude a grid whose latency level is the first level from the driving path.

The success rate calculator may accumulate statistical values through repeated driving for grids assigned a second or third-level latency and calculate the success rates for each grid based on these accumulated values. The driving path determiner may set a driving path selection priority proportional to the success rates for each grid on the network map, and determine the driving path based on the driving path selection priority.

The driving path determiner may update the network map and the driving path preset on the network map by incorporating the driving path selection priorities calculated for each grid.

The driving path determiner may exclude a specific grid having a success rate of 50% or lower from the driving path.

When an abnormality is detected in a specific router, the network map generator may reduce an operating speed of the robot that measures the network latency for grids within a certain radius from a location of the specific router.

The driving path determiner may lower the driving path selection priority for grids within a certain radius of the specific router's location to a predefined level. When a shutdown of a specific router occurs, the network map generator may determine the latency levels for the grids within a certain radius from a location of the shutdown specific router as the first level.

According to another exemplary embodiment, a latency-based robot driving map generation method may include making a space into grids, and measuring network latency for each grid to generate a network map with assigned latency levels, calculating a success rate by repeated driving on a path on a grid to which a specific latency level is assigned in the network map, and setting driving path selection priorities for each grid based on the latency level and the success rate, and determining a driving path on the network map based on the driving path selection priority.

Generating the network map may include receiving an initial network map for the space through a control center, and measuring the network latency for each grid on the initial network map.

Generating the network map may include determining the latency level as a first level when the network latency is equal to or greater than a first criterion, a second level when the network latency is less than the first criterion and equal to or greater than a second criterion, and a third level when the network latency is less than the second criterion and equal to or greater than a third criterion, and the first to third criteria may vary depending on a service operation status of a driving robot.

Calculating the success rate may involve accumulating statistical values through repeated driving for grids assigned a second or third-level latency and calculating the success rates for each grid based on these accumulated values. The determining of the driving path may include excluding a grid whose latency level is the first level from the driving path.

The determining of the driving path may include updating the network map and the driving path preset on the network map in real time by reflecting the driving path selection priorities for each grid proportional to the success rate.

The determining of the driving path may further include excluding a specific grid having a success rate of 50% or less from the driving path.

When an abnormality is detected in a specific router, generating the network map may involve reducing the operating speed of the robot measuring network latency for grids within a certain radius of the router's location. Determining the driving path may include reducing the driving path selection priority set for grids within the certain radius from the location of the specific router to a certain level.

When a shutdown of a specific router occurs, the generating of the network map may further include determining the latency levels for the grids within a certain radius from a location of the shutdown specific router as the first level.

According to the latency-based robot driving map generation apparatus and method according to an exemplary embodiment of the present disclosure, by automatically updating and managing the latest map reflecting the network status and managing the detailed tasks of the robot in the form that enables the unmanned operation, it is possible to reduce the frequency of service failure in the network problem situation.

According to the latency-based robot driving map generation apparatus and method according to an exemplary embodiment of the present disclosure by managing the network status as the variable in addition to the physical obstacles, it is possible to stably drive the robot and improve the completeness of robot products and services.

### BRIEF DESCRIPTION OF THE DRAWINGS

FIG. 1 is a schematic diagram illustrating a latency-based robot driving map generation system in accordance with an exemplary embodiment of the present disclosure.

FIG. 2 is a block diagram of a latency-based robot driving map generation apparatus in accordance with an exemplary embodiment of the present disclosure.

FIG. 3 is a diagram illustrating a network map in accordance with an exemplary embodiment of the present disclosure.

FIG. 4 is a flowchart depicting a latency-based robot driving map generation method in accordance with an exemplary embodiment of the present disclosure.

FIG. 5 is a flowchart illustrating the latency-based robot driving map generation method in accordance with an exemplary embodiment of the present disclosure.

FIG. 6 is a diagram describing the latency-based robot driving map generation method in accordance with an exemplary embodiment of the present disclosure.

FIG. 7 is a flowchart illustrating an operation of a robot in a network issue situation in accordance with an exemplary embodiment of the present disclosure.

FIG. 8 is a diagram describing a latency-based robot driving map generation method in accordance with another exemplary embodiment of the present disclosure.

FIG. 9 is a diagram describing the latency-based robot driving map generation method in accordance with another exemplary embodiment of the present disclosure.

FIG. 10 is a diagram describing a computing device in accordance with an exemplary embodiment of present disclosure.

### DETAILED DESCRIPTION OF THE EMBODIMENTS

Hereinafter, the present invention will be described in greater detail with reference to the accompanying drawings, which illustrate embodiments of the invention. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements. Terms including an ordinal number such as first, second, etc., may be used to describe various components, but the components are not limited to these terms. The above terms are used solely for the purpose of distinguishing one component from another.

Terms such as “. . . unit,” “. . . er/or,” and “module,” as used in the specification, refer to components capable of performing at least one function or operation described herein. These may be implemented as hardware, circuits, software, or a combination of hardware and software. Hereinafter, exemplary embodiments of the present disclosure are described with reference to the drawings.

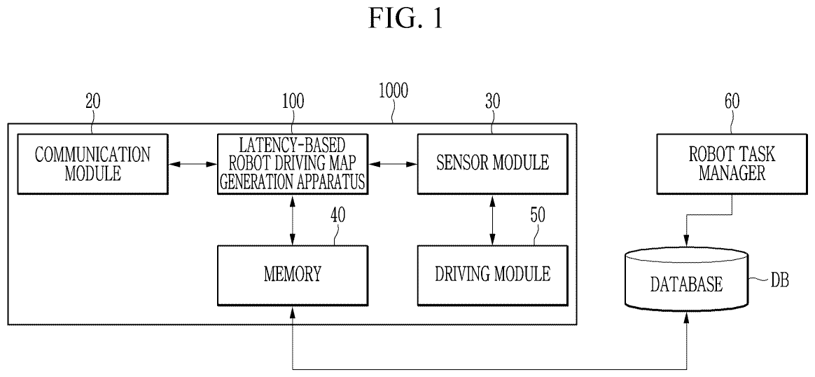

FIG. 1 is a schematic diagram illustrating a latency-based robot driving map generation system according to an exemplary embodiment of the present disclosure.

A latency-based robot driving map generation system 1000 may be mounted on a driving robot. That is, the latency-based robot driving map generation system 1000 may be implemented as a driving robot.

Referring to FIG. 1, the latency-based robot driving map generation system 1000 comprises a latency-based robot driving map generation apparatus 100, a communication module 20, a sensor module 30, a memory 40, and a driving module 50.

The latency-based robot driving map generation apparatus 100, the communication module 20, the sensor module 30, the memory 40, and the driving module 50 may be connected via a network.

The latency-based robot driving map generation apparatus 100 may be implemented as a processor. It receives data from the communication module 20 and the sensor module 30 and processes the data to generate a robot driving map. That is, the latency-based robot driving map generation apparatus 100 may receive the strength of a communication signal from the communication module 20 and receive and match points of interest (POIs) from the sensor module 30.

The communication module 20 transmits and receives data with other modules through a communication network. The communication module 20 may measure the strength of the communication signal and the network latency for each POI during transmitting and receiving data.

The sensor module 30 may include a lidar sensor for creating an indoor map. The sensor module 30 may include various positioning sensors for measuring a location indoors for autonomous driving.

The memory 40 may include various types of volatile or nonvolatile memory media and store the generated network map, the robot driving map, and various data. The memory 40 stores data generated from the latency-based robot driving map generation apparatus 100.

The driving module 50 drives the mobile robot and may receive driving-related data from the sensor module 30. The latency-based robot driving map generation system 1000 may be connected to a robot task manager 60 and a database (DB) through a network.

The robot task manager 60 may manage unit tasks of robot services such as movement, object detection, and utterance of a robot. In an exemplary embodiment, the robot task manager 60 may measure the success rate of the unit task. The robot task manager 60 may store the measured success rate in the database (DB).

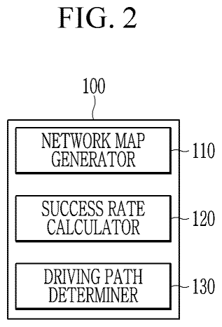

The database (DB) may be a server connected to the memory, used to periodically store and manage generated map data. FIG. 2 is a block diagram of a latency-based robot driving map generation apparatus according to an exemplary embodiment of the present disclosure.

Referring to FIG. 2, the latency-based robot driving map generation apparatus 100 may include a network map generator 110, a success rate calculator 120, and a driving path determiner 130.

The network map generator 110 may make a space into grids. That is, the network map generator 110 may make the entire map of a space to be measured into N×N grids. The space to be measured may be a space in which a robot drives.

The network map generator 110 may measure network latency for each grid.

The network map generator 110 may assign each latency level based on the network latency measured for each grid.

The network map generator 110 generates a network map with latency levels assigned to each grid. The network map generator 110 may determine the latency level as a first level when the network latency is equal to or greater than a first criterion. For example, the network map generator 110 may determine the latency level of the corresponding grid as a high level when the latency of the grid is 1000 m/s or more.

The network map generator 110 may determine the latency level as a second level when the network latency is less than the first criterion and equal to or greater than a second criterion. For example, the network map generator 110 may determine the latency level of the corresponding grid as a medium level when the latency is less than 1000 m/s and is 500 m/s or more.

The network map generator 110 may determine the latency level as a third level when the network latency is less than the second criterion and is equal to or greater than a third criterion. For example, the network map generator 110 may determine the latency level of the corresponding grid as a low level when the latency is less than 500 m/s and is 100 m/s or more.

The first to third criteria may dynamically change based on the service operation status of the driving robot. When the network map generator 110 detects the occurrence of abnormality in a specific router, it is possible to reduce an operating speed of the robot that measures the network latency for grids within a certain radius from a location of a specific router.

That is, the network map generator 110 may refine latency-based mapping through a slow-moving robot.

When a shutdown of a specific router occurs, the network map generator 110 may determine the latency levels for the grids within a certain radius from a location of the shutdown specific router as the first level or the high level.

The network map generator 110 may assign the highest latency level to unmeasured grids, ensuring they are excluded from the driving path. The success rate calculator 120 may calculate a success rate by repeated driving on a path on a grid to which a specific latency level is assigned in the network map.

The success rate calculator 120 may accumulate a statistical value by repeated driving for grids to which the second level or the third level is assigned, and calculate the success rates for each grid based on the accumulated statistical value.

The driving path determiner 130 may generate the driving path on the network map based on the latency level and the success rate.

The driving path determiner 130 excludes grids with a latency level of the first level or high level from the driving path. In other words, it excludes grids with a latency of 1000 ms or more. The driving path determiner 130 may set each driving path selection priority proportional to success rates for each grid on the network map.

The driving path determiner 130 may determine the driving path based on the driving path selection priorities.

The driving path determiner 130 may update the network map and the driving path preset on the network map by reflecting the driving path selection priorities for each grid calculated in real time.

The driving path determiner 130 excludes grids with a success rate of 50% or less from the driving path. The driving path determiner 130 may reduce the driving path selection priority set for grids within a certain radius from the location of the specific router, in which the abnormality is discovered, to a certain level.

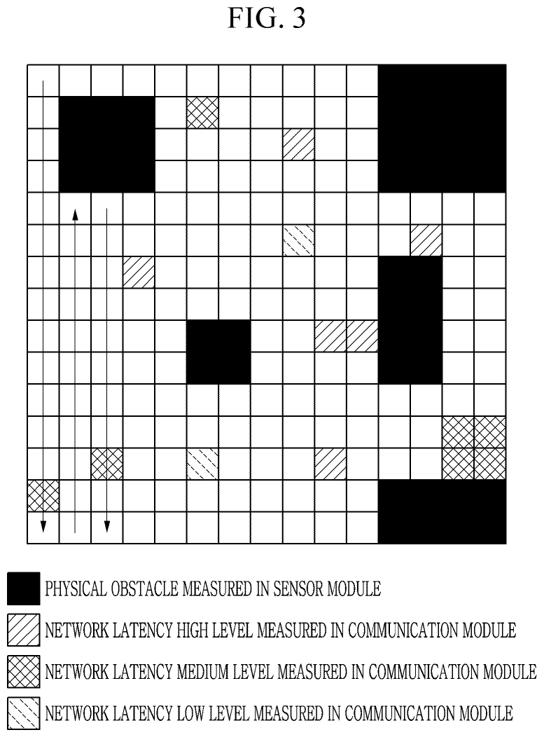

FIG. 3 is a diagram illustrating a network map according to an exemplary embodiment of the present disclosure.

The latency-based robot driving map generation apparatus 100 may generate a network map using information measured from the communication module 20 (see FIG. 1) and the sensor module 30 (see FIG. 1).

The latency-based robot driving map generation apparatus 100 may make the existing map into grids and measure latency for each grid to generate the network map to which the latency level is assigned.

In FIG. 3, the network map includes a plurality of grids. The grids may be displayed differently based on latency levels. Each grid distinguishes between cases of normal and abnormal latency. For example, grids with normal latency and grids with abnormal latency may be displayed in different colors.

Some grids may be displayed as physical obstacles measured detected by the sensor module 30.

Some grids with abnormal latency may have a high latency level as measured by the communication module 20. Other grids with abnormal latency may have medium or low latency levels. In the network map, some of the grids having the high level, the medium level, and the low level, respectively, may be distinguished through different colors. Alternatively, the network level may be displayed on the grids of the network map. The network level may be represented by a number. For example, the high level may be represented by 3, the medium level may be represented by 2, and the low level may be represented by 1 on the network map.

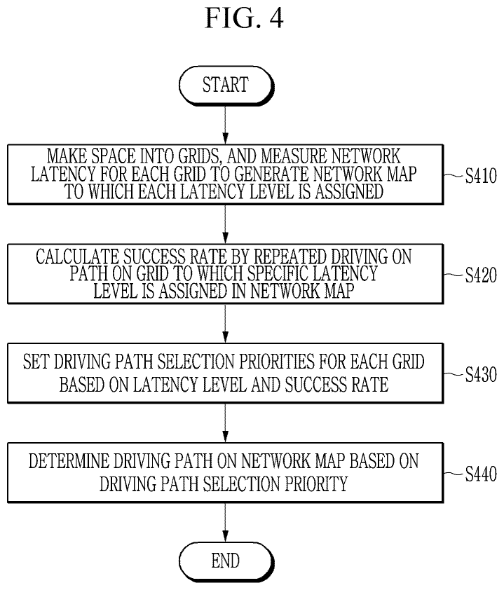

FIG. 4 is a flowchart of the latency-based robot driving map generation method according to an exemplary embodiment of the present disclosure. The latency-based robot driving map generation method of FIG. 4 may be performed using the latency-based robot driving map generation apparatus 100 (see FIG. 2).

In FIG. 4, the latency-based robot driving map generation apparatus 100 may make a space into grids and measure network latency for each grid to create a network map to which each latency level is assigned (step S410).

The latency-based robot driving map generation apparatus 100 may calculate a success rate by repeated driving on a path on a grid to which a specific latency level is assigned in the network map (step S420).

Here, the success rate may mean a work success rate or a task success rate. The success rate may mean a predefined robot task success frequency. In other words, the success rate may be statistics on whether the task or driving of the robot is finally successful in a grid of a specific latency level.

For example, when a destination movement from point A to point B on the network map is successful, the success rate may be determined based on the number of times of successes for multiple movement requests.

Alternatively, in the case of goods delivery, if a specific task such as receiving/loading/elevator boarding of goods in a specific grid is attempted and succeeds according to a predefined operation, the success rate may be determined based on the number of times of successes compared to the total number of requests.

In an exemplary embodiment, the latency-based robot driving map generation apparatus 100 directly measures the success rate using the success rate calculator 120 (see FIG. 2). In this case, it receives task execution information for the robot from the robot task manager 60 (see FIG. 1). Alternatively, the latency-based robot driving map generation apparatus 100 may receive the task success rate measured by the robot task manager 60.

The latency-based robot driving map generation apparatus 100 may set driving path selection priorities for each grid based on the latency level and the success rate (step S430).

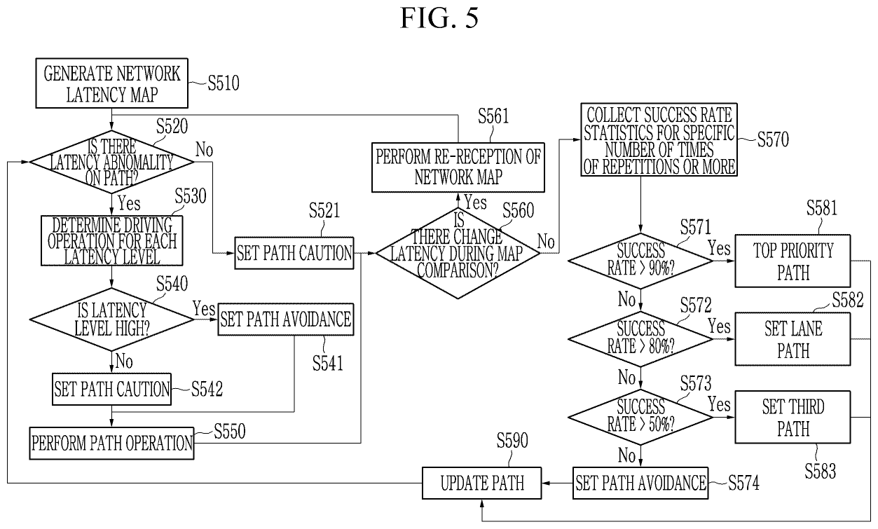

The latency-based robot driving map generation apparatus 100 determines the driving path on the network map based on the assigned driving path selection priorities (step S440). FIG. 5 is a flowchart depicting the latency-based robot driving map generation method according to an exemplary embodiment of the present disclosure. FIG. 5 is a diagram specifically describing a latency-based robot driving map generation method of FIG. 4.

In FIG. 5, the latency-based robot driving map generation apparatus 100 may generate a network map (or network latency map) to which a latency level regarding network latency for each grid is assigned (step S510).

The latency-based robot driving map generation apparatus 100 may determine whether the latency abnormality has occurred in a grid on a path while a robot is driving (step S520).

If there is no grid on the driving path where the latency abnormality has occurred, the latency-based robot driving map generation apparatus 100 may perform the driving operation on the driving path (step S521). That is, the latency-based robot driving map generation apparatus 100 may issue a command to perform a path operation to the driving module 50 (see FIG. 1).

When there is the latency abnormality on the path, the latency-based robot driving map generation apparatus 100 may determine the driving operations for each latency level (step S530).

The latency-based robot driving map generation apparatus 100 may first determine whether the latency level of the grid on the path of the network map is a high level (step S540). For example, when the latency is 1000 m/s or more, it may be determined as the high level. When the latency is less than 1000 m/s and 500 m/s or more, it may be determined as the medium level. When the latency is less than 1000 m/s and 100 m/s or more, it may be determined as the low level.

The criteria for determining latency levels may vary based on the robot's service environment or operating status. If the latency level is classified as high, the latency-based robot driving map generation apparatus 100 may be set to avoid the corresponding grid (step S541). That is, the latency-based robot driving map generation apparatus 100 may exclude a high-level grid from the driving path.

If the latency level of the grid on the path is not high, the latency-based robot driving map generation apparatus 100 may set the corresponding grid to a path caution because it still has the medium level or the low level (step S542).

The latency-based robot driving map generation apparatus 100 may operate a robot along a path with path avoidance settings or path caution settings for some of the abnormality grids (step S550).

The latency-based robot driving map generation apparatus 100 may check in real time whether there is a change in the latency information of each grid of the network map during the path operation (step S560).

If there is a change in the latency information, the latency-based robot driving map generation apparatus 100 may re-receive the network map having the changed latency information (step S561).

The latency-based robot driving map generation apparatus 100 may re-perform steps S520 to S550 with the re-received network map.

If there is no change in the latency information, the latency-based robot driving map generation apparatus 100 may repeatedly perform the robot operation along the set path and collect the statistics of the success rate for a specific number of times of repetitions or more (step S570).

That is, the latency-based robot driving map generation apparatus 100 may accumulate statistical values by repeated driving for grids to which the second or third level is assigned, and calculate the success rates for each grid based on the accumulated statistical values.

The success rate may be determined by the success frequency compared to the total requests for predefined robot tasks in each grid.

The latency-based robot driving map generation apparatus 100 determines whether the success rate is greater than 90% (step S571), and if so, may set a top priority path for the corresponding grid (step S581). That is, the latency-based robot driving map generation apparatus 100 may determine the path selection priority as a first priority for a grid with a success rate greater than 90%.

The latency-based robot driving map generation apparatus 100 determines whether the success rate is 80% or more when the success rate is 90% or less (step S572), and if so, may set a lane path for the corresponding grid (step S582). That is, the latency-based robot driving map generation apparatus 100 may determine the path selection priority as the second priority for a grid having the success rate of 80% or more and 90% or less.

The latency-based robot driving map generation apparatus 100 determines if the success rate is between 50% and 80% (step S573). The latency-based robot driving map generation apparatus 100 may set a third-priority path for a grid having a success rate of 50% or more (step S583). That is, the latency-based robot driving map generation apparatus 100 may assign a third-priority path selection priority for a grid having a success rate of 80% or less and 50% or more.

The latency-based robot driving map generation apparatus 100 may set a path avoidance for a grid having a success rate of 50% or less (step S574). That is, the latency-based robot driving map generation apparatus 100 may exclude a specific grid of a 50% or less from the driving path.

In other words, the success rate and the path selection priority are proportional. The latency-based robot driving map generation apparatus 100 may update the network map and the driving path preset on the network map in real time by reflecting the driving path selection priorities for each grid that is proportional to the success rate (step S590).

The latency-based robot driving map generation apparatus 100 may repeat steps S520 to S590 with the updated driving path.

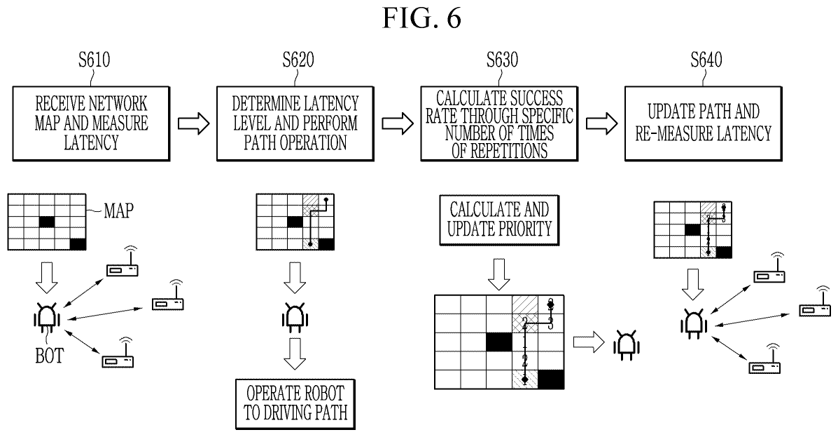

FIG. 6 is a diagram describing the latency-based robot driving map generation method according to an exemplary embodiment of the present disclosure.

In FIG. 6, the latency-based robot driving map generation apparatus 100 receives an initial network map for a measurement space from a control center and measure the network latency for each grid on the initial network map (step S610).

The latency-based robot driving map generation apparatus 100 may determine the latency level based on the measured network latency and operate a robot (BOT) along a path set based on the latency level (step S620).

More specifically, the latency-based robot driving map generation apparatus 100 may determine caution/avoidance for a grid on a path of a network map (MAP) based on the latency and perform the driving or task operation of the robot along the determined path.

The latency-based robot driving map generation apparatus 100 repeats the robot's path operation a specific number of times, calculates the success rate, and then re-determines the path based on the calculated success rate (step S630). The latency-based robot driving map generation apparatus 100 may update the network map based on the calculated success rate and update the path on the network map (step S640).

That is, the latency-based robot driving map generation apparatus 100 may update the driving path determined based on the latency and the success rate on the network map to generate the robot driving map.

The latency-based robot driving map generation apparatus 100 may re-measure the latency through the robot on the network latency map whose path is updated and assign the level (step S640).

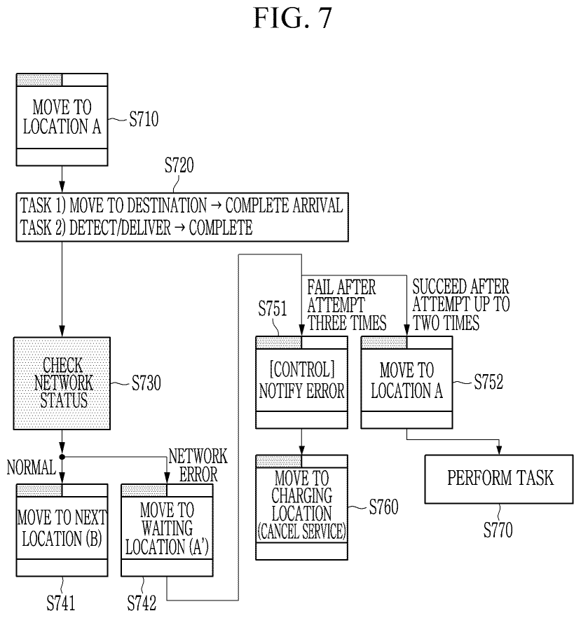

The latency-based robot driving map generation apparatus 100 repeats steps S610 to S640 using the network map with re-assigned latency levels. FIG. 7 is a flowchart illustrating an operation of a robot in a network issue situation according to an exemplary embodiment of the present disclosure. Here, the robot may be a robot equipped with a latency-based robot driving map generation system 1000 (see FIG. 1).

In FIG. 7, the robot moves to location A to perform the assigned task (step S710).

When the network disconnection occurs during the movement after the robot task is normally received, it is generally handled by the control center. When the operation status information of the robot changes, the information is transmitted to the control center, and the robot may additionally determine the network disconnection when the information is not transmitted.

The robot may move to a destination to which the robot intends to move when the network is restored and may perform the task.

The robot arrives at location A and may complete the detection/delivery task (step S720).

Thereafter, the robot may check the network status (step S730). When the network disconnection occurs at the time of detection completion after arriving at the POI, the robot determines that the network is disconnected when the performance result is not transmitted from the maintenance location.

The robot moves to the next location if the task is determined to be successful during the network status check (step S741). When the network is determined to be disconnected, the robot may move to a waiting location and proceed with recovery (step S742). The robot may determine that the network is restored when the result is normally transmitted.

The robot attempts the network recovery three times or more, and then, when the recovery is not possible, transmits a network error notification to the control center (step S751). Thereafter, the robot moves to a charging location and may cancel the service (step S760).

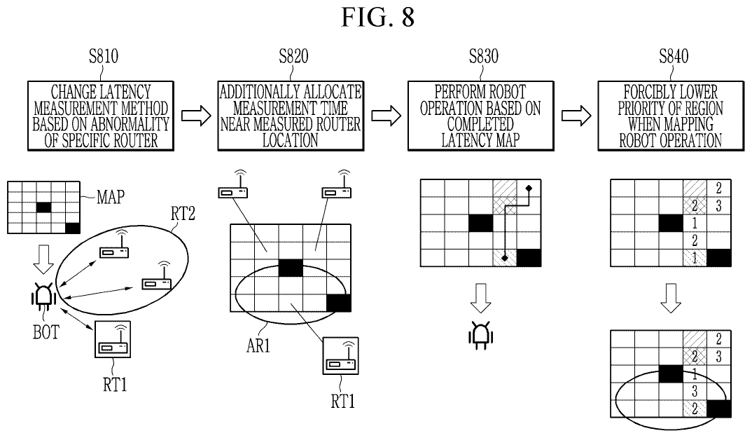

If the network recovery is successful after two attempts, the robot moves back to location A, its previous location (step S752), and performs the task (step S770). FIG. 8 is a diagram for describing a latency-based robot driving map generation method in accordance with another exemplary embodiment of the present disclosure.

In FIG. 8, the latency-based robot driving map generation apparatus 100 may change the latency measurement method when a specific router RT1 among a plurality of routers has an abnormality (step S810).

For example, the latency-based robot driving map generation apparatus 100 may repeat a measured amount of allocation of another router RT2 when a latency significantly increases, or packet loss occurs at a specific location due to the abnormality in the specific router RT1.

The latency-based robot driving map generation apparatus 100 additionally allocates latency measurement time near the location of another router (RT2) being measured (step S820). For example, the latency-based robot driving map generation apparatus 100 may identify an approximate location of the specific router RT1 where the abnormality has occurred using a received signal strength indicator (RSSI).

When the latency-based robot driving map generation apparatus 100 detects the abnormality in the specific router RT1, it may reduce the operation speed of the robot by measuring the network latency for grids within a certain radius AR1 from the location of the specific router RT1 and may refine the latency mapping.

The latency-based robot driving map generation apparatus 100 performs the robot operation based on the completed latency map (step S830).

The latency-based robot driving map generation apparatus 100 may set the robot path and perform the operation execution through the completed network latency map.

The latency-based robot driving map generation apparatus 100 lowers the priority of the corresponding area when mapping robot operations (step S840). For example, the latency-based robot driving map generation apparatus 100 may determine the path selection priority on the motion path and reduce the grids included in the certain radius AR1 near the abnormality router RT1 by one step from the preset priority.

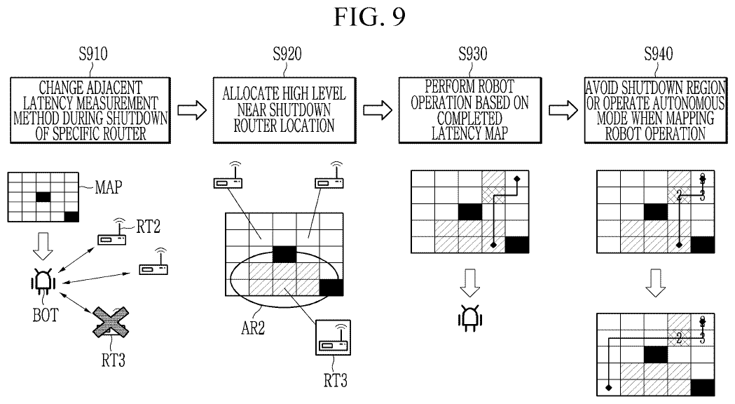

FIG. 9 is a diagram describing the latency-based robot driving map generation method according to another exemplary embodiment of the present disclosure.

In FIG. 9, the latency-based robot driving map generation apparatus 100 may change the nearby latency measurement method when a specific router RT3 is shut down (step S910).

For example, the latency-based robot driving map generation apparatus 100 may only perform the measurement of another router RT2 when the specific router RT3 is shut down. Whether to shut down the specific router RT3 may be determined based on the reception of information through the router or multiple communication failures.

The latency-based robot driving map generation apparatus 100 may allocate the high-level latency to grids within the certain radius AR2 near the location of the shutdown router RT3 (step S920).

The latency-based robot driving map generation apparatus 100 operates the robot based on the completed network latency map (step S930). The latency-based robot driving map generation apparatus 100 may avoid the router shutdown area AR2 when mapping through the robot operation. Alternatively, the latency-based robot driving map generation apparatus 100 may enable the robot to operate in an autonomous mode (step S940).

For example, the latency-based robot driving map generation apparatus 100 may set all grids that are distinguished as the high level (e.g., red color) in the network map on the operation path of the robot (BOT) to be avoided.

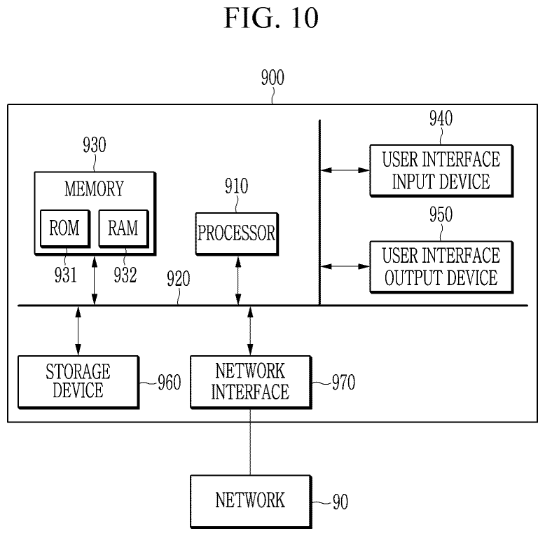

In other words, the robot (BOT) performs avoidance driving if the area near the destination is marked as high level or drives to the destination in autonomous mode. FIG. 10 is a diagram describing a computing device according to an exemplary embodiment of present disclosure.

Referring to FIG. 10, the latency-based robot driving map generation apparatus and method described in the exemplary embodiments can be implemented using a computing device 900. The computing device 900 may include at least one of a processor 910, a memory 930, a user interface input device 940, a user interface output device 950, and a storage device 960 that communicate via a bus 920. The computing device 900 may also include a network interface 970 that is electrically connected to a network 90. The network interface 970 may transmit or receive signals to and from other entities through the network 90.

The processor 910 may be implemented in various types such as a micro controller unit (MCU), an application processor (AP), a central processing unit (CPU), a graphic processing unit (GPU), a neural processing unit (NPU), and may be any semiconductor device that executes instructions stored in the memory 930 or the storage device 960. The processor 910 may be configured to implement the functions and methods described above with reference to FIGS. 1 to 9.

The memory 930 and the storage device 960 may include various types of volatile or non-volatile storage media. For example, the memory may include a read only memory (ROM) 931 and a random access memory (RAM) 932. In an exemplary embodiment of the present disclosure, the memory 930 may be positioned inside or outside the processor 910, and the memory 930 may be connected to the processor 910 through various means that are well-known.

In some embodiments, components or functions of the latency-based robot driving map generation apparatus and method can be implemented as software or a program running on the computing device 900, and this software or program may be stored on a computer-readable medium. In some exemplary embodiments, at least some components or functions of the latency-based robot driving map generation apparatus and method according to the exemplary embodiments are implemented using hardware or circuits of the computing device 900, or may be implemented as separate hardware or circuit that may be electrically connected to the computing device 900.

While the embodiments of the present disclosure have been described in detail, the scope of the present disclosure is not limited to these descriptions. It encompasses modifications and alterations made by those skilled in the art, based on the fundamental concepts of the present disclosure as defined in the claims. <Description of symbols>
20: Communication module
30: Sensor module
40: Memory
50: Driving module
60: Robot task manager
100: Latency-based robot driving map generation apparatus
110: Network map generator
120: Success rate calculator
130: Driving path determiner

What is claimed is:

1. A latency-based robot driving map generation apparatus, comprising:
a network map generator configured to divide a space into grids, and measure network latency for each grid to generate a network map with an assigned latency level for each grid,
a success rate calculator configured to calculate a success rate by repeated driving on a path in a grid assigned a specific latency level in the network map, and
a driving path determiner configured to determine a driving path on the network map based on the assigned latency level and the calculated success rate.

2. The latency-based robot driving map generation apparatus of claim 1, wherein:
the network map generator is configured to determine:
the latency level,
as a first level when the network latency is equal to or greater than a first criterion,
a second level when the network latency is less than the first criterion and equal to or greater than a second criterion, and
a third level when the network latency is less than the second criterion and equal to or greater than a third criterion, and
the first to third criteria vary depending on a service operation status of a driving robot.

3. The latency-based robot driving map generation apparatus of claim 2, wherein:
the driving path determiner
excludes from the driving path any grid assigned the first latency level.

4. The latency-based robot driving map generation apparatus of claim 3, wherein:
the success rate calculator
accumulates a statistical value through repeated driving operations for grids assigned the second level or the third level and calculates the success rates for each grid based on the accumulated statistical value.

5. The latency-based robot driving map generation apparatus of claim 1, wherein:
the driving path determiner
sets a driving path selection priority proportional to the calculated success rates for each grid on the network map and determines the driving path based on the driving path selection priority.

6. The latency-based robot driving map generation apparatus of claim 5, wherein:
the driving path determiner
updates the network map and a driving path preset on the network map by reflecting the driving path selection priorities for each grid calculated in real time.

7. The latency-based robot driving map generation apparatus of claim 6, wherein:
the driving path determiner
excludes from the driving path any grid with a success rate of 50% or less.

8. The latency-based robot driving map generation apparatus of claim 5, wherein:
when an abnormality is detected in a specific router, the network map generator reduces an operating speed of the robot measuring the network latency for grids within a certain radius from a location of the specific router.

9. The latency-based robot driving map generation apparatus of claim 8, wherein:
the driving path determiner reduces the driving path selection priority set for grids within the certain radius from the location of the specific router to a certain level.

10. The latency-based robot driving map generation apparatus of claim 3, wherein:
when a specific router shuts down, the network map generator assigns the first latency level to the grids within a certain radius of the shutdown router's location.

11. A latency-based robot driving map generation method, comprising:
dividing a space into grids, and measuring network latency for each grid to generate a network map with assigned latency levels using a network map generator,
calculating a success rate through repeated driving on a path within a grid to which a specific latency level is assigned in the network map using a success rate calculator, and
setting driving path selection priorities for each grid based on the latency level and the calculated success rate and determining a driving path on the network map based on the driving path selection priority, using a driving path determiner.

12. The latency-based robot driving map generation method of claim 11, wherein:
the generating of the network map includes:
receiving an initial network map for the space through a control center and measuring the network latency for each grid on the initial network map using the network map generator.

13. The latency-based robot driving map generation method of claim 11, wherein:
the generating of the network map includes using the network map generator to:
determine the latency level
as a first level when the network latency is equal to or greater than a first criterion,
a second level when the network latency is less than the first criterion and equal to or greater than a second criterion, and
a third level when the network latency is less than the second criterion and equal to or greater than a third criterion, and
the first to third criteria vary depending on a service operation status of a driving robot.

14. The latency-based robot driving map generation method of claim 13, wherein:
the calculating of the success rate includes using the success rate calculator to:
accumulate statistical value through repeated driving operations for grids assigned the second or third latency level and calculate the success rates for each grid based on the accumulated statistical value.

15. The latency-based robot driving map generation method of claim 14, wherein:
the determining of the driving path includes using the driving path determiner to:
exclude any grid assigned the first latency level from the driving path.

16. The latency-based robot driving map generation method of claim 11, wherein:
the determining of the driving path includes using the driving path determiner to:
update the network map and a driving path preset on the network map in real time by reflecting the driving path selection priorities for each grid proportional to the success rate.

17. The latency-based robot driving map generation method of claim 16, wherein:
the determining of the driving path further includes using the driving path determiner to:
exclude from the driving path any specific grids with a success rate of 50% or less.

18. The latency-based robot driving map generation method of claim 11, wherein:
when an abnormality is detected in a specific router, the generating of the network map includes using the driving path determiner to:
reduce an operating speed of the robot measuring the network latency for grids within a certain radius from a location of the specific router.

19. The latency-based robot driving map generation method of claim 18, wherein:
the determining of the driving path includes using the driving path determiner to:
reduce the driving path selection priority set for grids within the certain radius from the location of a specific router to a certain level.

20. The latency-based robot driving map generation method of claim 15, wherein:
when a specific router shuts down, the generating of the network map further includes using the network map generator to:
determine the first latency level to the grids within a certain radius of the shutdown router's location.
